(19) United States
(12) Patent Application Publication
(10) Pub. No.: US 2013/0346543 A1
(43) Pub. Date: Dec. 26, 2013

(54) CLOUD SERVICE SELECTOR

(71) Applicants: Messaoud B. Benantar, Austin, TX (US); David Y. Chang, Austin, TX (US); John Y. Chang, Austin, TX (US); Vishwanath Venkataramappa, Austin, TX (US)

(72) Inventors: Messaoud B. Benantar, Austin, TX (US); David Y. Chang, Austin, TX (US); John Y. Chang, Austin, TX (US); Vishwanath Venkataramappa, Austin, TX (US)

(73) Assignee: International Business Machines Corporation, Armonk, NY (US)

(21) Appl. No.: 13/530,267

(22) Filed: Jun. 22, 2012

(51) Int. Cl. G06F 15/16

(52) U.S. Cl. 709/217

(57) ABSTRACT

In a method for selecting a remote application service from a plurality of remote application services containing a requested electronic resource, a computer receives a request for an electronic resource. The computer sends a request for a geographic location of each node in the plurality of nodes containing the electronic resource. The computer determines a distance between the geographic location of each node in the plurality of nodes and the geographic location of the origin of the request for the electronic resource, respectively. The computer selects a remote application service based at least partially on the distance between the geographic location of each node and the geographic location of the origin of the request for the electronic resource.

### TECHNICAL FIELD

The present invention relates generally to the information technology environment and more specifically to selecting which cloud service to utilize to access a specific electronic resource that has been distributed across multiple cloud services.

### BACKGROUND

The networked computing environment (e.g., cloud computing environment) is an enhancement to the predecessor grid environment, whereby multiple grids and other computation resources may be further enhanced by one or more additional abstraction layers (e.g., a cloud layer), thus making disparate devices appear to an end-consumer as a single pool of seamless resources. These resources may include such things as physical or logical computing engines, servers and devices, device memory, and storage devices, among others.

Cloud service providers (remote application services) are companies that offer cloud computing services to businesses or individual consumers. A consumer (user) can register for multiple cloud services and replicate the consumer owned resource across different services. Examples of consumer owned electronic resources are digital music, digital pictures, and application software.

### SUMMARY

Aspects of one embodiment of the present invention disclose a method, system, and a program product for selecting a remote application service from a plurality of remote application services containing a requested electronic resource. The method includes a computer receiving a request for an electronic resource. The method further includes the computer identifying a plurality of nodes containing the electronic resource; each node in the plurality of nodes is associated with a respective remote application service. The method further includes the computer sending a request for a geographic location of each node in the plurality of nodes containing the electronic resource. The method further includes the computer receiving a geographic location of an origin of the request for the electronic resource. The method further includes the computer receiving the geographic location of each node in the plurality of nodes containing the electronic resource. The method further includes the computer determining a distance between the geographic location of each node in the plurality of nodes and the geographic location of the origin of the request for the electronic resource, respectively. The method further includes the computer selecting a remote application service based at least partially on the distance between the geographic location of each node and the geographic location of the origin of the request for the electronic resource.

### BRIEF DESCRIPTION OF THE SEVERAL VIEWS OF THE DRAWINGS

FIG. 1 depicts a diagram of a computing system in accordance with one embodiment of the present invention.

FIG. 2 depicts a flowchart of the steps of a service selector program executing within the computing system of FIG. 1, for selecting a cloud service provider (remote application service) from a plurality of cloud service providers each comprising a node that contains a requested electronic resource, in accordance with one embodiment of the present invention.

FIG. 3 depicts a flowchart of the steps of a service selector program executing within the computing system of FIG. 1, for selecting a cloud service provider (remote application service) from a plurality of cloud service providers each comprising a node that contains a requested electronic resource, in accordance with another embodiment of the present invention.

FIG. 4 depicts a computing node in accordance with one embodiment of the present invention.

FIG. 5 depicts a cloud computing environment in accordance with one embodiment of the present invention.

FIG. 6 depicts abstraction model layers in accordance with one embodiment of the present invention.

### DETAILED DESCRIPTION

It is understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed. A detailed description of cloud computing is given in this section to provide a better understanding of the underlying teachings discussed herein.

The present invention will now be described in detail with reference to the figures.

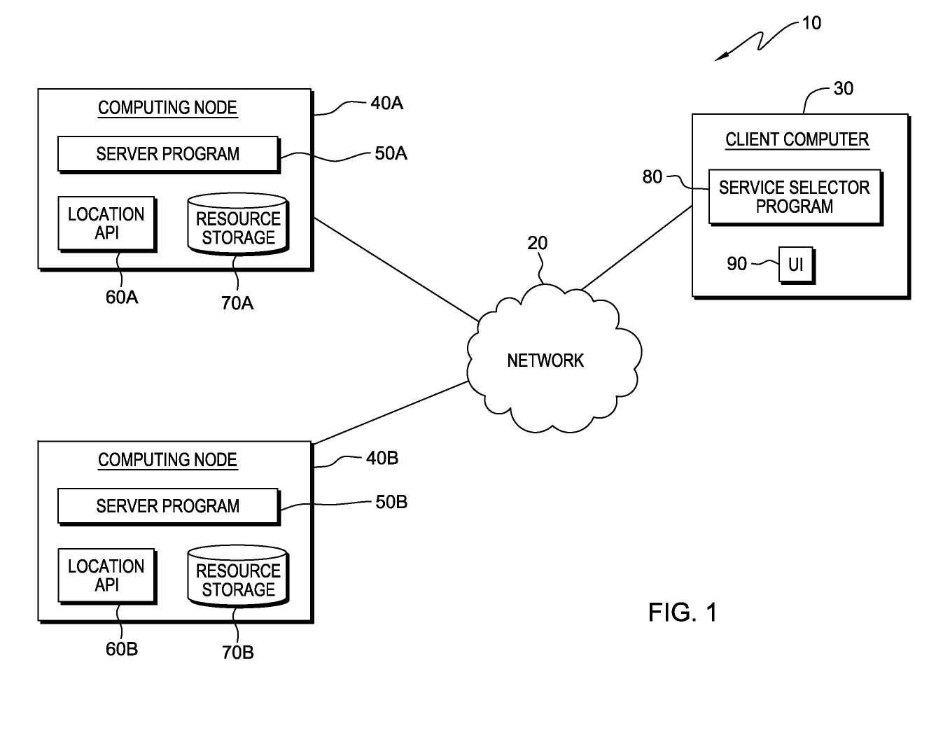

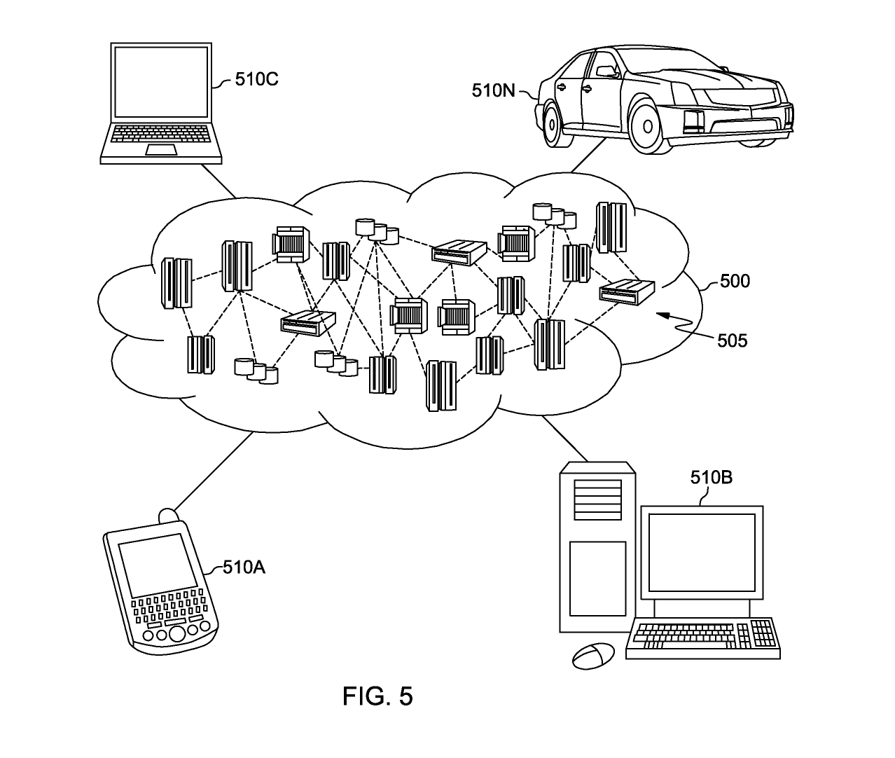

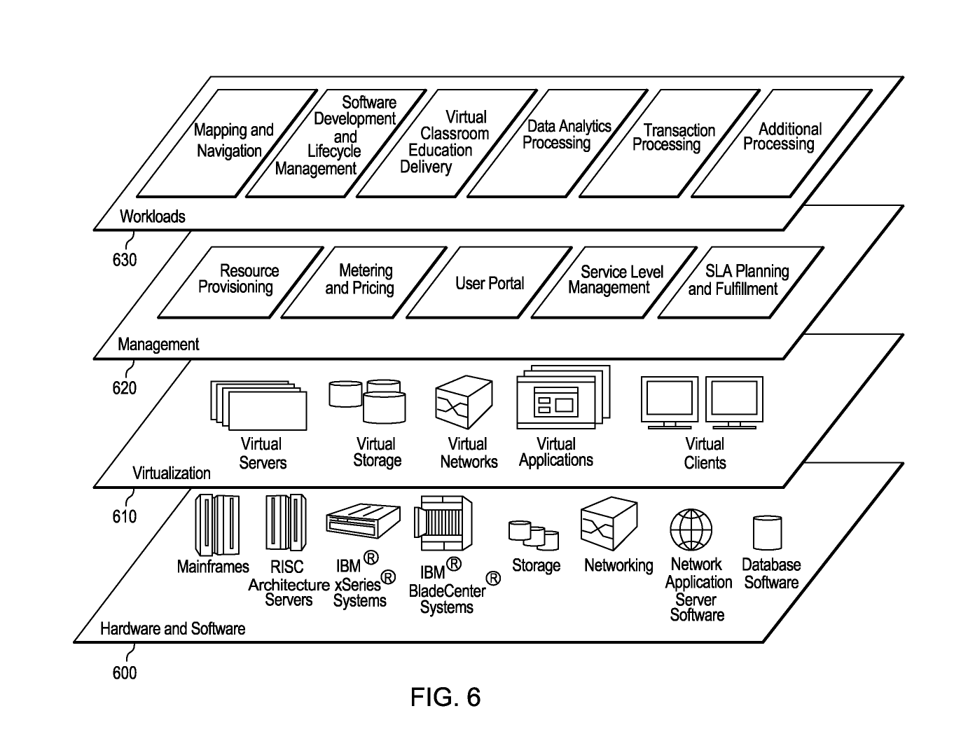

FIG. 1 depicts a diagram of computing environment 10 in accordance with one embodiment of the present invention. FIG. 1 provides only an illustration of one embodiment and does not imply any limitations with regard to the environments in which different embodiments may be implemented. In another embodiment, computing environment 10 is a cloud computing environment as described in reference to FIGS. 5 and 6.

In the depicted embodiment, computing environment 10 includes client computer 30, computing node 40A, and computing node 40B, interconnected over network 20. Network 20 is a wide area network (WAN) such as the Internet. In other embodiments, network 20 may be a local area network (LAN), or any combination of connections and protocols that will support communications between client computer 30, computing node 40A, and computing node 40B in accordance with embodiments of the invention. Network 20 may include wired, wireless, or fiber optic connections. Computing environment 10 may include additional computing nodes, client computers, or other devices not shown.

In other embodiments, there may be a cloud broker service that acts as an intermediary between a consumer (user) and cloud service providers. These cloud brokers can communicate with multiple cloud service providers and can negotiate service level agreements with the cloud service providers based on consumer preferences. They can also provide the consumer (user) with service metrics of each cloud service provider.

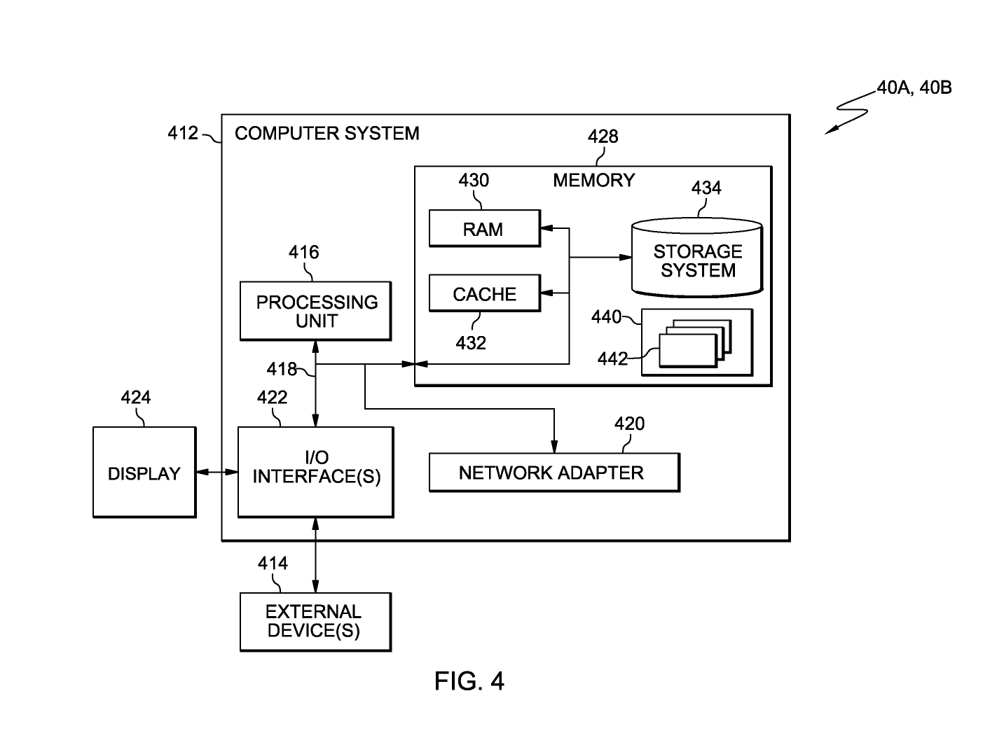

Client computer 30 is a smart phone. In other embodiments, client computer 30 may be a desktop computer, laptop computer, tablet computer, or personal digital assistant (PDA). In general, client computer 30 may be any electronic device or computing system capable of sending and receiving data, and communicating with computing nodes 40A and 40B over network 20. In one embodiment, client computer 30 can have the components of computer system 412 described in reference to FIG. 4. Client computer 30 contains service selector program 80 and user interface (UI) 90.

Computing node 40A and computing node 40B are nodes, belonging to different cloud service providers, each are capable of sending and receiving data, and communicating with client computer 30 over network 20. In one embodiment, computing nodes 40A and 40B are nodes as described in reference to FIG. 4. Computing node 40A contains server program 50A, location Application Programming Interface (API) 60A and resource storage 70A. Computing node 40B contains server program 50B, location API 60B and resource storage 70B. In other embodiments, computing nodes 40A and 40B may be management servers, web servers, or any other electronic devices or computing systems capable of receiving and sending data.

Server programs 50A and 50B are network application server software programs that operate to manage services provided by a cloud service provider and manage requests of client programs, such as service selector program 80. In one embodiment, server programs 50A and 50B are network application server software in a cloud computing environment, as described in reference to FIG. 6. In one embodiment, server programs 50A and 50B execute on computing nodes 40A and 40B, respectively. In other embodiments, server programs 50A and 50B may reside on other servers or other computing devices, provided that server programs 50A and 50B are accessible to service selector program 80.

Resource storage 70A and 70B are repositories that may be written and read by server programs 50A and 50B, respectively. Data managed by server programs 50A and 50B is stored on resource storage 70A and 70B, respectively. In one embodiment, resource storage 70A and 70B are network storage in a cloud computing environment, as described in reference to FIG. 6. In other embodiments, resource storage 70A and 70B can be any repository that can be written and read by server programs 50A and 50B, respectively, and are accessible to service selector program 80. For example, resource storage 70A and 70B may be a database such as an Oracle® database or an IBM® DB2® database.

Location API's 60A and 60B are application programming interfaces that programs can call to receive the location of computing nodes 40A and 40B, respectively. A Global Positioning System (GPS) receiver (not shown) is connected to each of computing nodes 40A and 40B. The GPS receiver should be positioned so as to provide at least the location of the building the computing node is in. A GPS receiver can determine its location and present that location as longitude and latitude coordinates. In one embodiment, location API's 60A and 60B reside on computing nodes 40A and 40B, respectively. In other embodiments, location API's 60A and 60B may reside on other servers or other computing devices provided that location API's 60A and 60B have access to the GPS receiver connected to computing nodes 40A or 40B, respectively, and are accessible to service selector program 80.

User interface 90 operates on client computer 30 to visualize content, such as icons and application material, and allows a user to request a specific electronic resource, stored remotely. User interface 90 may comprise one or more interfaces, such as an operating system interface and application interfaces. User interface 90 receives the name of the electronic resource from user input and reports the name of the electronic resource to service selector program 80.

Service selector program 80 operates to select a cloud service provider (remote application service) from a plurality of cloud service providers each comprising a node that contains a requested electronic resource. Service selector program 80 determines the distance between the geographic location of each node that contains the requested electronic resource and the geographic location of the origin of the request for the electronic resource. Service selector program 80 selects a cloud service provider from a plurality of cloud service providers, each comprising a node that contains the requested electronic resource, based at least partially on the distance between the geographic location of each node and the geographic location of the origin of the request for the electronic resource.

The origin of the request for the electronic resource is the location where a user requests a specific electronic resource. For example, if a user requests an electronic resource using user interface 90 on client computer 30, the origin of the request for the electronic resource would be client computer 30. In one embodiment, geographic location is expressed as longitude and latitude coordinates of a geographic coordinate system determined by a GPS receiver.

In one embodiment, service selector program 80 determines the distance between the geographic location of each node that contains the requested electronic resource and the geographic location of the origin of the request for the electronic resource. Service selector program 80 selects a cloud service provider from a plurality of cloud service providers, each comprising a node that contains the requested electronic resource, based on the distance between the geographic location of each node and the geographic location of the origin of the request for the electronic resource. The cloud service provider comprising the node with the smallest distance to the origin of the request for the electronic resource is selected.

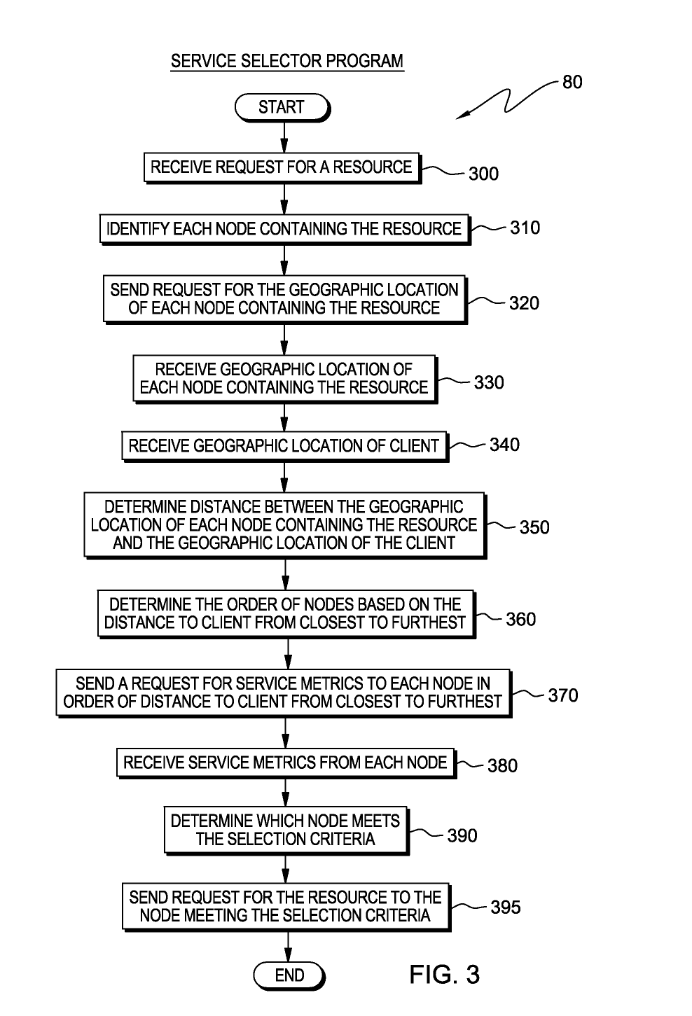

In another embodiment, service selector program 80 determines the distance between the geographic location of each node that contains the requested electronic resource and the geographic location of the origin of the request for the electronic resource. Service selector program 80 sends a request for a service metric to each node that contains the requested electronic resource in order of distance to the origin of the request from smallest to largest. Service selector program 80 will determine, based on the service metric (discussed in reference to FIG. 3), which node containing the requested electronic resource meets selection criteria set by the user who requested the electronic resource.

Service selector program 80 resides on client computer 30. In other embodiments, service selector program 80 may reside on other servers or other computing devices, provided that service selector program 80 is accessible to user interface 90 and has access to server programs 50A and 50B, and location API's 60A and 60B. Service selector program 80 may be embodied as program module 442 stored in memory 428 of FIG. 4. (Further depicted as the “additional processing” function of workloads layer 630 of FIG. 6).

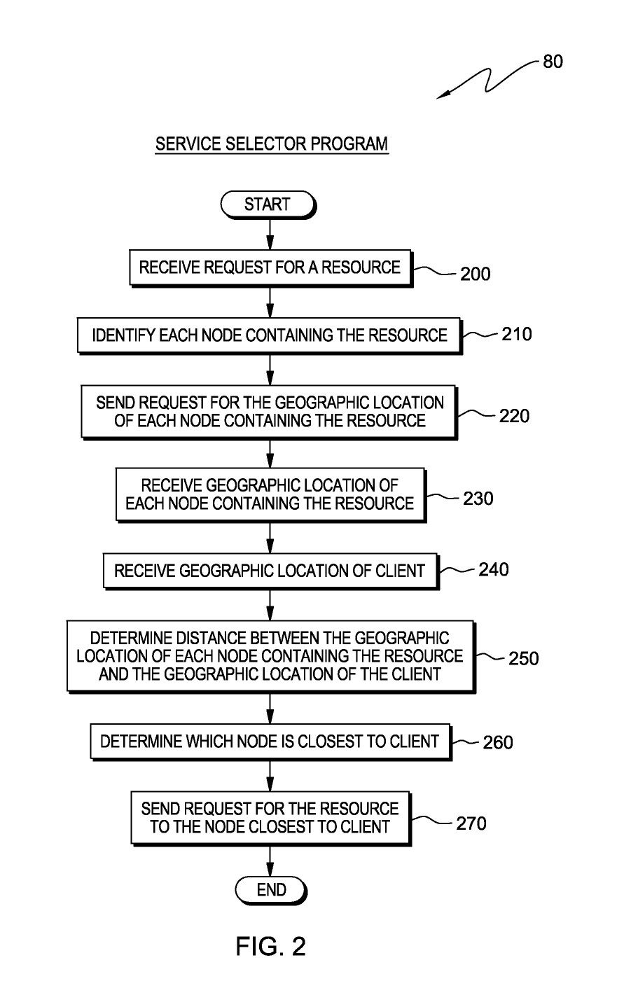

FIG. 2 depicts a flowchart of the steps of service selector program 80 executing within the computing system of FIG. 1, for selecting a cloud service provider (remote application service) from a plurality of cloud service providers each comprising a node that contains a requested electronic resource, in accordance with one embodiment of the present invention.

In one embodiment, initially, a user at client computer 30 will register with a plurality of cloud service providers and enter account information for each of the cloud service providers in to service selector program 80 so as to allow service selector program 80 to access the plurality of cloud service providers. The user will also upload an electronic resource to each of the plurality of cloud service providers using service selector program 80. Service selector program 80 sends the electronic resource to server programs 50A and 50B. Server programs 50A and 50B store the electronic resource in resource storage 70A and 70B, respectively. In another embodiment, the electronic resource may be uploaded to each of the plurality of cloud service providers using a program specific to cloud service provider or a user interface, such as a web browser.

In one embodiment, the user, from user interface 90 requests an electronic resource stored remotely in resource storage 70A and 70B of computing nodes 40A and 40B, respectively. The request for the electronic resource is sent to service selector program 80 from user interface 90. In another embodiment, the request for the electronic resource is sent to server programs 50A and 50B and then an indication of that request is forwarded to service selector program 80, over network 20.

In step 200, service selector program 80 receives a request for an electronic resource from user interface 90. In response to receiving the request, service selector program 80 identifies a plurality of nodes (computing nodes 40A and 40B) that contain the requested electronic resource (step 210). In one embodiment, service selector program 80 queries a log file that contains the name of each electronic resource and the addresses (Internet Protocol Address) of the nodes where each electronic resource has been uploaded. In another embodiment, service selector program 80 will query each of the cloud service providers the user has registered with for nodes containing the requested electronic resource.

In step 220, service selector program 80 sends a request for the geographic location of computing nodes 40A and 40B. In one embodiment, service selector program 80 calls location API's 60A and 60B over network 20 to receive the geographic location of computing nodes 40A and 40B, respectively. In another embodiment, service selector program 80 queries server programs 50A and 50B for the service definition of computing nodes 40A and 40B which contain the geographic location of computing nodes 40A and 40B, respectively. The geographic locations are determined using GPS receivers and are saved in the service definitions of each node. Service selector program 80 receives the geographic location of computing nodes 40A and 40B (step 230).

In step 240, service selector program 80 receives the geographic location of the origin of the request for the electronic resource. In one embodiment, service selector program 80 calls a location API on client computer 30 to receive the geographic location of client computer 30. Client computer 30 is the origin of the request for the electronic resource if the user requests an electronic resource using user interface 90 on client computer 30.

In step 250, service selector program 80 determines the distance between the geographic location of each node that contains the requested electronic resource (computing nodes 40A and 40B) and the geographic location of the origin of the request for the electronic resource (client computer 30). In one embodiment, distance is the shortest distance between any two locations on a sphere (great-circle distance or “as the crow flies”). For example, service selector program 80 will determine the distances by using the longitude and latitude of a node and the longitude and latitude of the origin of the request in an algorithm to calculate distance between two sets of GPS longitude and latitude coordinates. In other embodiments, other algorithms may be used to determine distance depending on the desired accuracy.

In step 260, service selector program 80 determines which node in the plurality of nodes that contain the requested electronic resource (computing nodes 40A and 40B) is at a geographic location the smallest distance from the origin of the request for the electronic resource (client computer 30). In response to determining which node in the plurality of nodes (computing nodes 40A and 40B) is at a geographic location the smallest distance from the origin of the request for the electronic resource (client computer 30), service selector program 80 selects the cloud service provider (remote application service) associated with the node that is at a geographic location the smallest distance from the origin of the request for the electronic resource (client computer 30). In one embodiment, selecting the cloud service provider (remote application service) associated with the node that is at a geographic location the smallest distance from the origin of the request for the electronic resource (client computer 30) entails service selector program 80 sending the request for the electronic resource to server program of the node that is at a geographic location the smallest distance from the origin of the request for the electronic resource (step 270).

FIG. 3 depicts a flowchart of the steps of service selector program 80 executing within the computing system of FIG. 1, for selecting a cloud service provider (remote application service) from a plurality of cloud service providers each comprising a node that contains a requested electronic resource, in accordance with another embodiment of the present invention.

Steps 300 through 350 are equivalent to steps 200 through 250 discussed in reference to FIG. 2. In step 360, service selector program 80 determines the order of the plurality of nodes that contain the requested electronic resource (computing nodes 40A and 40B) in distance between the geographic location of each node that contains the requested electronic resource (computing nodes 40A and 40B) and the geographic location of the origin of the request for the electronic resource (client computer 30) from smallest to largest.

In response to determining the order of the plurality of nodes (computing nodes 40A and 40B) in distance between the geographic location of each node (computing nodes 40A and 40B) and the geographic location of the origin of the request for the electronic resource (client computer 30) from smallest to largest, in step 370 service selector program 80 sends a request for service metrics to each node in the plurality of nodes (computing nodes 40A and 40B) in the order determined in step 360. In one embodiment, service selector program 80 will query server programs 50A and 50B to retrieve the service metrics of computing nodes 40A and 40B, respectively. In other embodiments, if a cloud broker is utilized, service selector program will query the cloud broker for the service metrics of computing nodes 40A and 40B.

In one embodiment, a service metric is the round-trip time of a packet from the origin of the request for the electronic resource to each node in the plurality of nodes, respectively. Service selector program 80 queries server programs 50A and 50B using a ping utility if service selector program 80 is at the origin of the request for the electronic resource. If service selector program 80 is on a different computing device that is not at the origin, service selector program 80 will request that the computing device at the origin ping the nodes. In another embodiment, a ping utility operates by sending Internet Control Message Protocol (ICMP) echo request packets to the target host and waiting for an ICMP response. The round-trip time is measured, time from transmission to reception.

In another embodiment, a service metric may be the upload or download time of a specific file. Service selector program 80 sends a test file to server programs 50A and 50B if service selector program 80 is at the origin of the request for the electronic resource. If service selector program 80 is on a different computing device that is not at the origin, service selector program 80 will request that the computing device at the origin send the test file to the nodes. The test file is of a certain predetermined size. Multiple files with different sizes may also be used to give a range of results. The upload and download times are measured.

In other embodiments, other service metrics may be utilized, such as availability of the electronic resource (is the node containing the electronic resource up and running) or cost of the cloud service provider (e.g., if the provider charges based on usage).

In step 380, service selector program 80 receives service metrics from each node in the plurality of nodes (computing nodes 40A and 40B). In response to receiving service metrics from each node in the plurality of nodes (computing nodes 40A and 40B), service selector program 80 determines which node meets the selection criteria set by the user who requested the electronic resource (step 390). In one embodiment, the selection criteria are set by the user during the initial registration and upload processes described above. One example of a selection criterion is to select the cloud service provider (remote application service) associated with the node that has the fastest ping utility response time.

Service selector program 80 selects the cloud service provider (remote application service) associated with the node that meets the selection criteria set by the user. In one embodiment, selecting the cloud service provider (remote application service) associated with the node that meets the selection criteria entails service selector program 80 sending the request for the electronic resource to server program of the node that meets the selection criteria (step 395).

### Cloud Computing Description

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed, automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 4, FIG. 4 depicts a cloud computing node according to an embodiment of the present invention. Computing nodes 40A and 40B are only examples of suitable computing nodes and are not intended to suggest any limitation as to the scope of use or functionality of embodiments of the invention described herein. Regardless, computing nodes 40A and 40B are capable of being implemented and/or performing any of the functionality set forth hereinabove.

In each of computing nodes 40A and 40B, there is computer system 412, which is operational with numerous other general purpose or special purpose computing system environments or configurations. Examples of well-known computing systems, environments, and/or configurations that may be suitable for use with computer system 412 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 412 may be described in the general context of computer system-readable program instructions, such as program modules, being executed by a computer system. Generally, program modules may include routines, programs, objects, components, logic, data structures, and so on that perform particular tasks or implement particular abstract data types. Computer system 412 may be practiced in distributed cloud computing environments where tasks are performed by remote processing devices that are linked through a communications network. In a distributed cloud computing environment, program modules may be located in both local and remote computer system storage devices including memory storage devices.

As shown in FIG. 4, computer system 412 is shown in the form of a general-purpose computing device. The components of computer system 412 may include, but are not limited to, one or more processors 416, a memory 428, and a bus 418 that couples various system components including memory 428 to processor 416.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 412 typically includes a variety of computer system-readable tangible storage devices. Such devices may be any available device that is accessible by computer system 412, and it includes both volatile and non-volatile storage devices, removable and non-removable storage devices.

Memory 428 can include computer system-readable tangible storage devices in the form of volatile memory, such as random access memory (RAM) 430 and/or cache memory 432. Computer system 412 may further include other removable/non-removable, volatile/non-volatile computer system-readable tangible storage devices, on one or more of which program/utility 440 can be stored. By way of example only, storage system 434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as, a CD-ROM, DVD-ROM, or other optical media can be provided. In such instances, each can be connected to bus 418 by one or more data media interfaces. As will be further depicted and described below, memory 428 may include at least one program product having a set (e.g., at least one) of program modules that are configured to carry out the functions of embodiments of the invention.

Program code embodied on a computer-readable tangible storage devices may be transmitted using any appropriate medium including, but not limited to, wireless, wireline, optical fiber cable, radio-frequency (RF), etc., or any suitable combination of the foregoing.

Program/utility 440, having a set (at least one) of program modules 442, may be stored wholly or partially in memory 428 by way of example, and not limitation, as well as an operating system, one or more application programs, other program modules, and program data. Each of the operating system, one or more application programs, other program modules, and program data or some combination thereof, may include an implementation of a networking environment. Program modules 442 generally carry out the functions and/or methodologies of embodiments of the invention as described herein.

Program modules 442 can be written in various programming languages (such as Java, C++) including low-level, high-level, object-oriented or non object-oriented languages. Alternatively, the functions of program modules 442 can be implemented in whole or in part by computer circuits and other hardware (not shown).

Computer system 412 may also communicate with one or more external devices 414 such as a keyboard, a pointing device, a display 424, etc.; one or more devices that enable a consumer to interact with computer system 412; and/or any devices (e.g., network card, modem, etc.) that enable computer system 412 to communicate with one or more other computing devices. Such communication can occur via I/O interfaces 422. Still yet, computer system 412 can communicate with one or more networks such as a local area network (LAN), a general wide area network (WAN), and/or a public network (e.g., the Internet) via network adapter 420. As depicted, network adapter 420 communicates with the other components of computer system 412 via bus 418. It should be understood that although not shown, other hardware and/or software components could be used in conjunction with computer system 412. Examples include, but are not limited to: microcode, device drivers, redundant processing units, external disk drive arrays, RAID systems, tape drives, and data archival storage systems, etc.

FIG. 5 depicts a cloud computing environment according to an embodiment of the present invention. As shown, cloud computing environment 500 comprises one or more cloud computing nodes 505 with which local computing devices used by cloud consumers, such as, for example, personal digital assistant (PDA) or cellular telephone 510A, desktop computer 510B, laptop computer 510C, and/or automobile computer system 510N may communicate. Nodes 505 may communicate with one another. They may be grouped (not shown) physically or virtually, in one or more networks, such as private, community, public, or hybrid clouds as described hereinabove, or a combination thereof. This allows cloud computing environment 500 to offer infrastructure, platforms, and/or software as services for which a cloud consumer does not need to maintain resources on a local computing device. It is understood that the types of computing devices 510A-N shown in FIG. 5 are intended to be illustrative only and that computing nodes 505 and cloud computing environment 500 can communicate with any type of computerized device over any type of network and/or network addressable connection (e.g., using a web browser).

FIG. 6 depicts a set of functional abstraction layers provided by cloud computing environment 500 (FIG. 5) according to an embodiment of the present invention. It should be understood that the components, layers, and functions shown in FIG. 6 are intended to be illustrative only and embodiments of the invention are not limited thereto. As depicted, the following layers and corresponding functions are provided:

Hardware and software layer 600 includes hardware and software components. Examples of hardware components include mainframes. In one example, IBM® zSeries® systems and RISC (Reduced Instruction Set Computer) architecture based servers. In one example, IBM pSeries® systems, IBM System x® servers, IBM BladeCenter® systems, storage devices, networks, and networking components. Examples of software components include network application server software. In one example, IBM WebSphere® application server software and database software. In one example, IBM DB2® database software. (IBM, zSeries, pSeries, System x, BladeCenter, WebSphere, and DB2 are trademarks of International Business Machines Corporation registered in many jurisdictions worldwide.)

Virtualization layer 610 provides an abstraction layer from which the following examples of virtual entities may be provided: virtual servers; virtual storage; virtual networks, including virtual private networks; virtual applications and operating systems; and virtual clients.

In one example, management layer 620 may provide the functions described below. Resource provisioning provides dynamic procurement of computing resources and other resources that are utilized to perform tasks within the cloud computing environment. Metering and pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. Consumer portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 630 provides examples of functionality for which the cloud computing environment may be utilized. Examples of workloads and functions which may be provided from this layer include: mapping and navigation; software development and lifecycle management; virtual classroom education delivery; data analytics processing; transaction processing; and additional processing. As mentioned above, all of the foregoing examples described with respect to FIG. 6 are illustrative only, and the invention is not limited to these examples.

It is understood that all functions of the present invention as described herein typically may be performed by the additional processing functionality (of workloads layer 630, which can be tangibly embodied as modules of program modules 442 of program/utility 440 (FIG. 4). However, this need not be the case. Rather, the functionality recited herein could be carried out/implemented and/or enabled by any of the layers 600, 610, 620 or 630 shown in FIG. 6.

It is reiterated that although this disclosure includes a detailed description on cloud computing, implementation of the teachings recited herein are not limited to a cloud computing environment. Rather, the embodiments of the present invention are intended to be implemented with any type of networked computing environment now known or later developed.

The embodiments discussed herein pertain to selecting a cloud service provider (remote application service) from a plurality of cloud service providers each comprising a node that contains a requested electronic resource. Such an analysis could be performed by a cloud computing environment (as shown in FIGS. 5 and 6). However, this need not be the case.

Based on the foregoing, a computer system, a method and a program product have been disclosed for selecting a cloud service provider (remote application service) from a plurality of cloud service providers each comprising a node that contains a requested electronic resource. The description above has been presented for illustration purposes only. It is not intended to be an exhaustive description of the possible embodiments. One of ordinary skill in the art will understand that other combinations and embodiments are possible. Therefore, the present invention has been disclosed by way of example and not limitation.

What is claimed is:

1. A method for selecting a remote application service from a plurality of remote application services containing a requested electronic resource, the method comprising the steps of:
a computer receiving a request for an electronic resource;
the computer identifying a plurality of nodes containing the electronic resource, each node in the plurality of nodes is associated with a respective remote application service;
the computer sending a request for a geographic location of each node in the plurality of nodes containing the electronic resource;
the computer receiving a geographic location of an origin of the request for the electronic resource;
the computer receiving the geographic location of each node in the plurality of nodes containing the electronic resource;
the computer determining a distance between the geographic location of each node in the plurality of nodes and the geographic location of the origin of the request for the electronic resource, respectively; and
the computer selecting a remote application service based at least partially on the distance between the geographic location of each node and the geographic location of the origin of the request for the electronic resource.

2. The method of claim 1, wherein the step of the computer selecting a remote application service based at least partially on the distance between the geographic location of each node and the geographic location of the origin of the request for the electronic resource comprises the computer determining which node in the plurality of nodes closest in distance to the origin of the request for the electronic resource, and in response, the computer sending a request for the electronic resource to the node closest in distance to the origin of the request for the electronic resource.

3. The method of claim 1, wherein the step of the computer selecting a remote application service based at least partially on the distance between the geographic location of each node and the geographic location of the origin of the request for the electronic resource comprises:
the computer sending a request for a service metric of each node, to each node in the plurality of nodes in an order of the plurality of nodes in distance between the geographic location of each node in the plurality of nodes and the geographic location of the origin of the request for the electronic resource from smallest to largest;
the computer receiving the service metric of each node; and
the computer determining which service metric meets a selection criteria, and in response, the computer sending a request for the electronic resource to the node in the plurality of nodes with the service metric that meets the selection criteria.

4. The method of claim 1, wherein geographic location is expressed as longitude and latitude coordinates determined by a global positioning system.

5. The method of claim 1, wherein an origin of the request for the electronic resource comprises a computing system from which a user requested the electronic resource.

6. The method of claim 3, wherein a service metric comprises a round-trip time of an Internet Control Message Protocol (ICMP) echo request packet measured from transmission from the origin of the request for the electronic resource to each node to reception at the origin of the request for the electronic resource.

7. A computer program product comprising one or more computer-readable tangible storage devices and computer-readable program instructions which are stored on the one or more storage devices and when executed by the one or more processors of the computer of claim 1 perform the method of claim 1.

8. The computer of claim 1, the computer comprising one or more processors, one or more computer-readable memories, one or more computer-readable, tangible storage devices and program instructions which are stored on the one or more storage devices for execution by the one or more processors via the one or more memories and when executed by the one or more processors perform the method of claim 1.

9. A computer program product for selecting a remote application service from a plurality of remote application services containing a requested electronic resource, the computer program product comprising:
one or more computer-readable tangible storage devices and program instructions stored on at least one of the one or more storage devices, the program instructions comprising:
program instructions to receive a request for an electronic resource;
program instructions to identify a plurality of nodes containing the electronic resource, each node in the plurality of nodes is associated with a respective remote application service;
program instructions to send a request for a geographic location of each node in the plurality of nodes containing the electronic resource;
program instructions to receive a geographic location of an origin of the request for the electronic resource;
program instructions to receive the geographic location of each node in the plurality of nodes containing the electronic resource;
program instructions to determine a distance between the geographic location of each node in the plurality of nodes and the geographic location of the origin of the request for the electronic resource, respectively; and
program instructions to select a remote application service based at least partially on the distance between the geographic location of each node and the geographic location of the origin of the request for the electronic resource.

10. The computer program product of claim 9, wherein the program instructions to select a remote application service based at least partially on the distance between the geographic location of each node and the geographic location of the origin of the request for the electronic resource comprises program instructions to determine which node in the plurality of nodes closest in distance to the origin of the request for the electronic resource, and in response, program instructions to send a request for the electronic resource to the node closest in distance to the origin of the request for the electronic resource.

11. The computer program product of claim 9, wherein the program instructions to select a remote application service based at least partially on the distance between the geographic location of each node and the geographic location of the origin of the request for the electronic resource comprises:
program instructions to send a request for a service metric of each node, to each node in the plurality of nodes in an order of the plurality of nodes in distance between the geographic location of each node in the plurality of nodes and the geographic location of the origin of the request for the electronic resource from smallest to largest;
program instructions to receive the service metric of each node; and
program instructions to determine which service metric meets a selection criteria, and in response, program instructions to send a request for the electronic resource to the node in the plurality of nodes with the service metric that meets the selection criteria.

12. The computer program product of claim 9, wherein geographic location is expressed as longitude and latitude coordinates determined by a global positioning system.

13. The computer program product of claim 9, wherein an origin of the request for the electronic resource comprises a computing system from which a user requested the electronic resource.

14. The computer program product of claim 11, wherein a service metric comprises a round-trip time of an Internet Control Message Protocol (ICMP) echo request packet measured from transmission from the origin of the request for the electronic resource to each node to reception at the origin of the request for the electronic resource.

15. A computer system for selecting a remote application service from a plurality of remote application services containing a requested electronic resource, the computer system comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to receive a request for an electronic resource;
program instructions to identify a plurality of nodes containing the electronic resource, each node in the plurality of nodes is associated with a respective remote application service;
program instructions to send a request for a geographic location of each node in the plurality of nodes containing the electronic resource;
program instructions to receive a geographic location of an origin of the request for the electronic resource;
program instructions to receive the geographic location of each node in the plurality of nodes containing the electronic resource;
program instructions to determine a distance between the geographic location of each node in the plurality of nodes and the geographic location of the origin of the request for the electronic resource, respectively; and
program instructions to select a remote application service based at least partially on the distance between the geographic location of each node and the geographic location of the origin of the request for the electronic resource.

16. The computer system of claim 15, wherein the program instructions to select a remote application service based at least partially on the distance between the geographic location of each node and the geographic location of the origin of the request for the electronic resource comprises program instructions to determine which node in the plurality of nodes closest in distance to the origin of the request for the electronic resource, and in response, program instructions to send a request for the electronic resource to the node closest in distance to the origin of the request for the electronic resource.

17. The computer system of claim 15, wherein the program instructions to select a remote application service based at least partially on the distance between the geographic location of each node and the geographic location of the origin of the request for the electronic resource comprises:
program instructions to send a request for a service metric of each node, to each node in the plurality of nodes in an order of the plurality of nodes in distance between the geographic location of each node in the plurality of nodes and the geographic location of the origin of the request for the electronic resource from smallest to largest;
program instructions to receive the service metric of each node; and
program instructions to determine which service metric meets a selection criteria, and in response, program instructions to send a request for the electronic resource to the node in the plurality of nodes with the service metric that meets the selection criteria.

18. The computer system of claim 15, wherein geographic location is expressed as longitude and latitude coordinates determined by a global positioning system.

19. The computer system of claim 15, wherein an origin of the request for the electronic resource comprises a computing system from which a user requested the electronic resource.

20. The computer system of claim 17, wherein a service metric comprises a round-trip time of an Internet Control Message Protocol (ICMP) echo request packet measured from transmission from the origin of the request for the electronic resource to each node to reception at the origin of the request for the electronic resource.
